(19) United States
(12) Patent Application Publication
(10) Pub. No.: US 2020/0334556 A1
(43) Pub. Date: Oct. 22, 2020

(54) DYNAMIC PREFETCHING OF ONTOLOGIES BASED ON ML-BASED EXECUTION PATTERN RECOGNITION

(71) Applicant: Cisco Technology, Inc., San Jose, CA (US)

(72) Inventors: Smruti Dilip Lele, Milpitas, CA (US); Samer Salam, Beirut (LB); Ajay Madhavan, Milpitas, CA (US)

(73) Assignee: Cisco Technology, Inc.

(21) Appl. No.: 16/386,371

(22) Filed: Apr. 17, 2019

(51) Int. Cl. G06N 5/04; G06N 20/00; G06F 17/27

(52) U.S. Cl. CPC G06N 5/047; G06F 17/2785; G06N 20/00

(57) ABSTRACT

In one embodiment, a device in a network obtains data indicative of one or more execution sequences of a semantic reasoner. The device trains a machine learning model to predict use of an ontology by the semantic reasoner, based on the data indicative of the one or more execution sequences of the semantic reasoner. The device predicts, using the machine learning model, use of a particular ontology by the semantic reasoner. The device prefetches the particular ontology from another device via the network, prior to the semantic reasoner completing an execution sequence that requires the particular ontology.

### TECHNICAL FIELD

The present disclosure relates generally to computer networks, and, more particularly, to the dynamic prefetching of ontologies based on machine learning (ML)-based execution pattern recognition.

### BACKGROUND

Networks are large-scale distributed systems governed by complex dynamics and very large number of parameters. In general, network quality involves applying analytics to captured network information, to assess the health of the network. For example, a network quality service may track and assess metrics such as available bandwidth, packet loss, jitter, and the like, to ensure that the experiences of users of the network are not impinged. However, as networks continue to evolve, so too will the number of applications present in a given network, as well as the number of metrics available from the network.

As computer networks continue to evolve, knowledge-based systems represent a promising approach to addressing the increasing complexity of monitoring and automating the operations of a network. In general, knowledge-based systems leverage semantic reasoning, to make inferences and draw a conclusion about a particular topic. In contrast to machine learning approaches that offer only unexplainable conclusions, such as deep learning-based approaches, a key feature of semantic reasoning is the ability of the semantic reasoner to also detail the chain of inferences that led to the conclusion. To do so, a semantic reasoner typically leverages a knowledge base in the form of an ontology.

While knowledge-based systems can enhance the performance of a computer network, ontologies can also be quite large. Particularly in the case of distributed semantic reasoning, this can lead to significant resource overhead on both the network and on the device performing the reasoning.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example execution dependency graph for a semantic reasoner;

FIG. 5 illustrates an example architecture for prefetching an ontology for a semantic reasoner;

FIG. 6 illustrates an example execution dependency graph for a semantic reasoner with assigned probabilities of use;

FIG. 7 illustrates an example perceptron-based model for predicting use of an ontology by a semantic reasoner;

FIG. 8 illustrates an example execution dependency graph for a semantic reasoner with dependency labels; and

FIG. 9 illustrates an example simplified procedure for prefetching an ontology for a semantic reasoner.

### DESCRIPTION OF EXAMPLE EMBODIMENTS

### Overview

According to one or more embodiments of the disclosure, a device in a network obtains data indicative of one or more execution sequences of a semantic reasoner. The device trains a machine learning model to predict use of an ontology by the semantic reasoner, based on the data indicative of the one or more execution sequences of the semantic reasoner. The device predicts, using the machine learning model, use of a particular ontology by the semantic reasoner. The device prefetches the data from the particular ontology run from another device over the network, prior to the semantic reasoner completing an execution sequence that requires the particular ontology.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

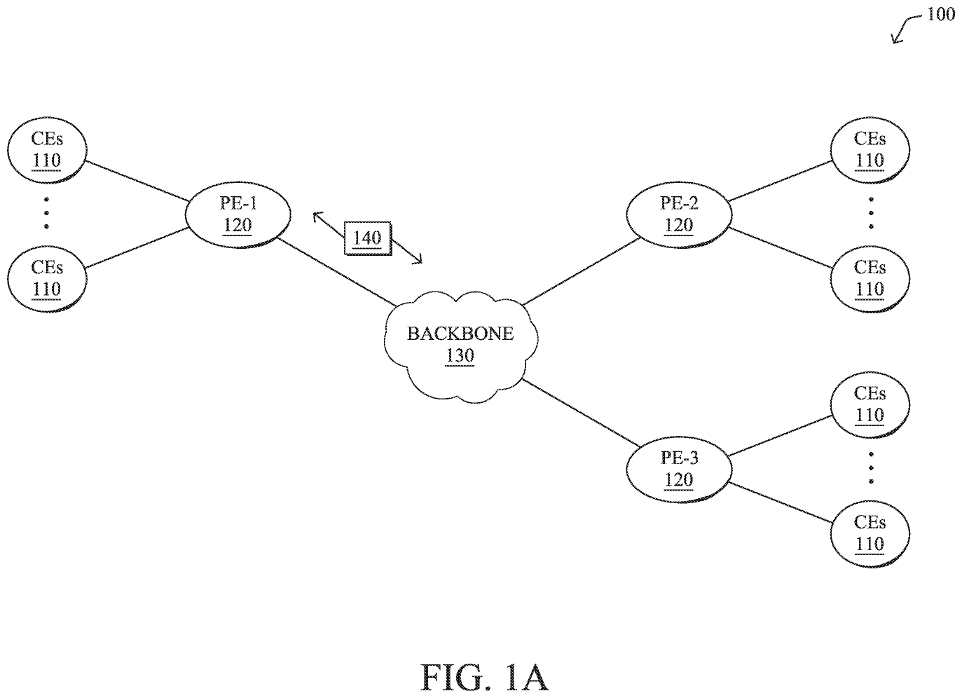

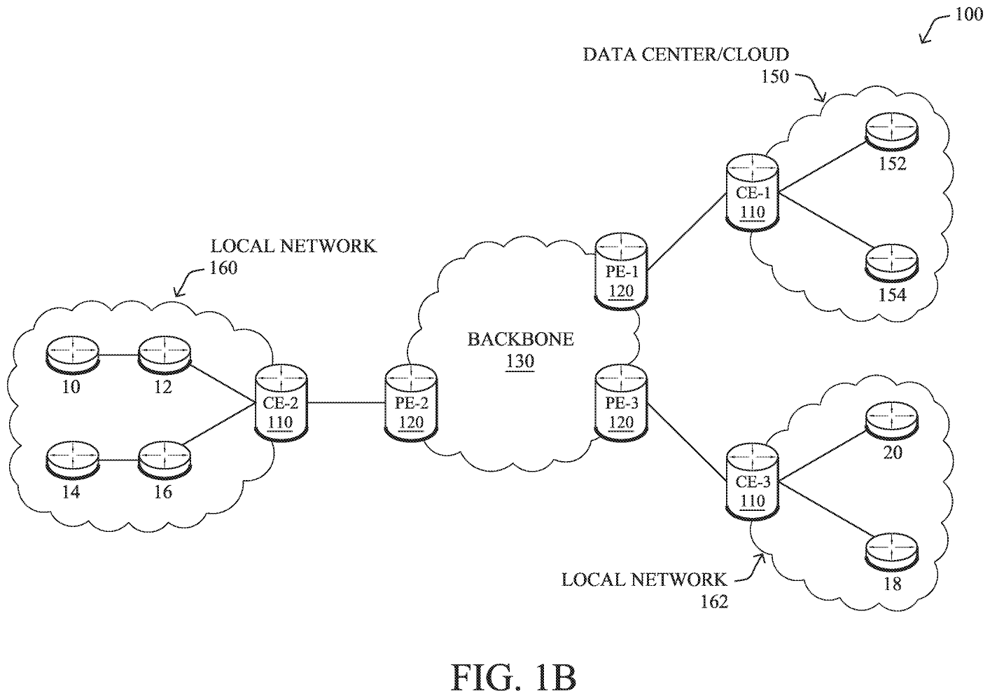

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an authentication, authorization and accounting (AAA) server, an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

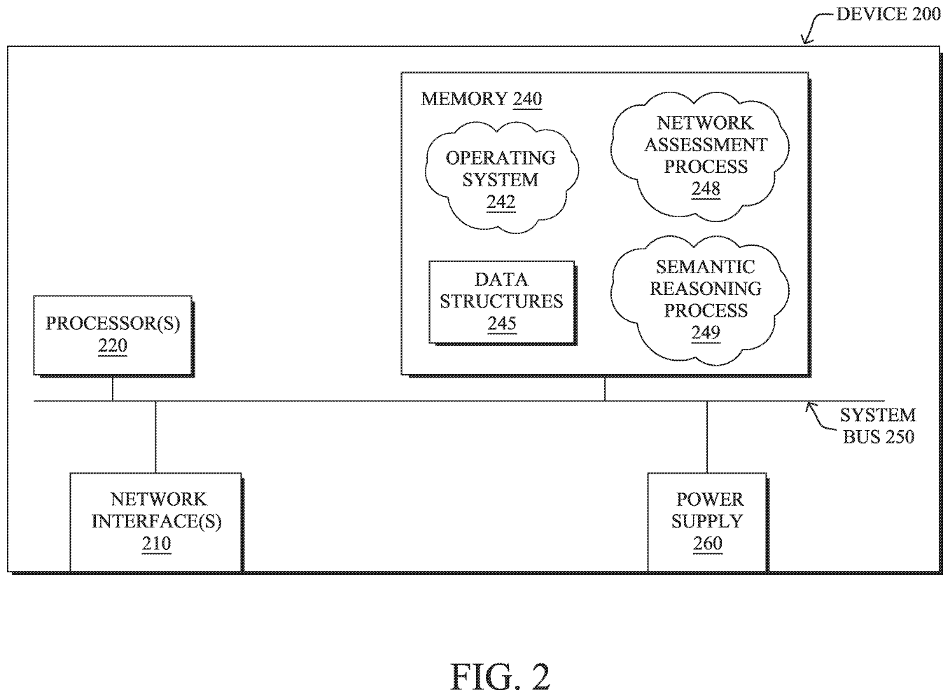

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248 and/or a semantic reasoning engine 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In various embodiments, network assurance process 248 may also utilize machine learning techniques, to enforce policies and to monitor the health of the network. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

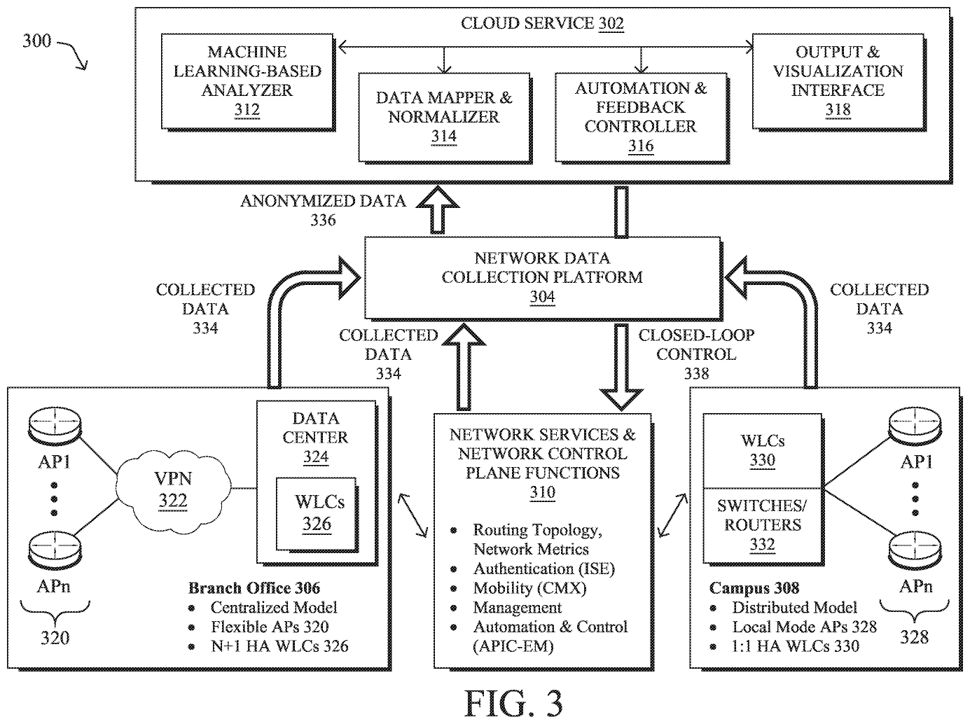

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 (e.g., supervisory devices that provide control over APs) located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning (ML)-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc.). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

In some embodiments, machine learning-based analyzer 312 may leverage semantic reasoning, to perform any or all of the above-listed functions. In other words, machine learning-based analyzer 312 may also implement a knowledge-based system to assess the health of the network, automate operations in the network, etc. In general, semantic reasoning leverages knowledge bases in the form of object models referred to as ‘ontologies’ that allow the semantic reasoner to make inferences and draw conclusions.

By way of example, consider the ancient Greek syllogism: (1.) All men are mortal, (2.) Socrates is a man, and (3.) therefore, Socrates is mortal. Depending on the formal language used for the reasoner, these statements can be represented as symbols of a term logic. For example, the first statement can be represented as “man→[mortal]” and the second statement can be represented as “{Socrates}→man.” Thus, the relationship between terms can be used by the reasoner to make inferences and arrive at a conclusion (e.g., “Socrates is mortal”). Non-axiomatic reasoners generally differ from more axiomatic reasoners in that the former applies a truth value to each statement, based on the amount of evidence available, while the latter relies on axioms that are treated as a baseline of truth from which inferences and conclusions can be made.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

While machine learning-based analyzer 312, data mapper and normalizer 314, automation and feedback controller 316, and output and visualization interface 318 are shown as part of cloud service 302, further embodiments provide for some or all of these components to be executed locally in the network(s) under observation. For example, APs 320, 328, WLCs 326, 330, switches/routers 332, or any other networking device in the local network may execute machine learning-based analyzer 312, to make local predictions, assessments, and/or control decisions.

As noted above, semantic reasoning typically relies on knowledge bases/ontologies, to make inferences and draw conclusions in an explainable manner. In the context of network assurance, this is a particularly powerful proposition as a semantic reasoner is able to both identify the root cause of an issue, as well as provide an explanation to the user as to why the reasoner reached that conclusion.

Ontologies can also be inter-related. For example, an ontology regarding the high-level topic of AP functionality may be related to a more specific ontology regarding beamforming in the 5 GHz spectrum. Thus, as a semantic reasoner continues to make inferences, it may transition between ontologies. For example, to diagnose the problem of packet loss between a particular wireless client and an AP, the semantic reasoner may consider the received signal strength indicator (RSSI) associated with the client, the number of clients attached to the AP, the channels used by the AP, etc., across any number of ontologies.

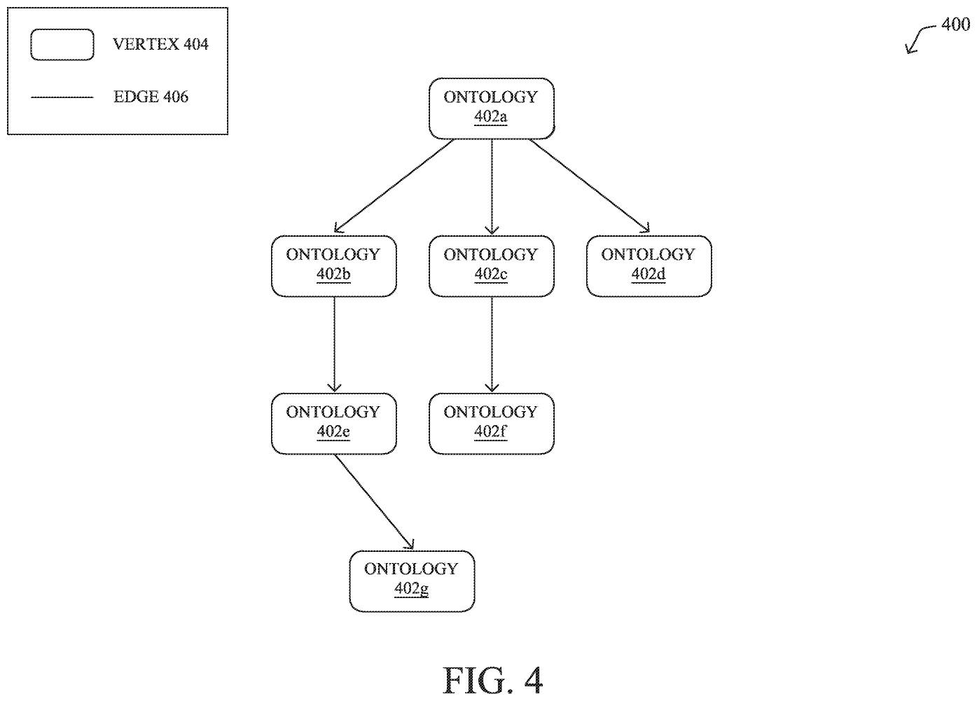

FIG. 4 illustrates an example execution dependency graph 400 for a semantic reasoner, in some embodiments. In the simplified example shown, each vertex 404 of graph 400 may represent a different ontology 402, such as ontologies 402a-402g. As would be appreciated, a semantic reasoner may use any number of ontologies, depending on its configuration. Also as shown, vertices 404 in graph 400 are connected by directed edges 406 that represent the transitions between ontologies 402 by the semantic reasoner during execution. For example, the semantic reasoner may begin with ontology 402a and transition to using one of ontologies 402b, 402c, or 402d, depending on the particular inferences made by the reasoner.

Unfortunately, ontologies can be quite large, in some cases. Consequently, a device executing a semantic reasoner may not have the resources available to persistently store all of the ontologies that it may need. One potential approach to overcoming this would be to store the set of ontologies as part of cloud service 302 and send the ontologies to the distributed semantic reasoner on an as-needed basis, at the time of reasoning. For example, if the reasoner is currently using ontology 402b and needs to transition to using ontology 402e, it may request ontology 402e from cloud service 302. However, the latency involved in the download of the requested ontology will also lead to a higher execution time of the reasoner and delays in resolving the network issue.

### Dynamic Prefetching of Ontologies Based on ML-Based Execution Pattern Recognition

The techniques herein introduce a machine learning (ML)-based approach to prefetching ontologies for a semantic reasoner, based on the execution patterns of the reasoner. In some aspects, machine learning can be leveraged to determine ontology path prediction scores for each of the ontologies that define the domain knowledge for the semantic reasoner and construct a dependency graph of the ontologies to determine the execution dependencies of the reasoner. Based on these probabilities, the device executing the semantic reasoner can predict which ontologies will be used next and prefetch them for use by the reasoner. This approach to reasoning allows for improved performance, particularly on heavily loaded devices that have limited available resources.

Specifically, in various embodiments, a device in a network obtains data indicative of one or more execution sequences of a semantic reasoner. The device trains a machine learning model to predict use of an ontology by the semantic reasoner, based on the data indicative of the one or more execution sequences of the semantic reasoner. The device predicts, using the machine learning model, use of a particular ontology by the semantic reasoner. The device prefetches the particular ontology from another device via the network, prior to the semantic reasoner completing an execution sequence that requires the particular ontology.

Illustratively, the techniques described herein may be performed by hardware, software, and/or firmware, such as in accordance with the semantic reasoning process 249, which may include computer executable instructions executed by the processor 220 (or independent processor of interfaces 210), to perform functions relating to the techniques described herein.

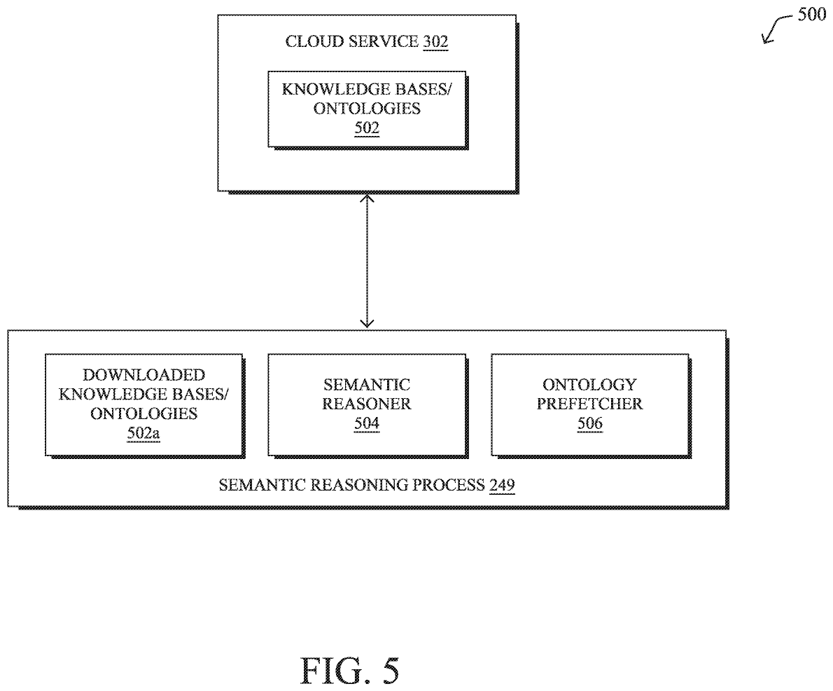

Operationally, FIG. 5 illustrates an example architecture 500 for prefetching an ontology for a semantic reasoner, according to various embodiments. As noted above, telemetry data from a monitored network may be exported to cloud service 302 for analysis or, alternatively, the analysis may be performed on-premises. For example, a device in the local network (e.g., a device 200), such as a router, switch, WLC, or other computing device, may execute semantic reasoning process 249.

At the core of semantic reasoning process 249 is semantic reasoner 404, which may be configured to use any number of knowledge bases/ontologies 502a downloaded from cloud service 302. In other words, cloud service 302 may store and maintain any number of knowledge bases/ontologies 502 that can be deployed for use by semantic reasoner 504 for purposes of determining the root cause of issues in the network, adjusting the operation of the network and/or device(s) in the network, etc.

In various embodiments, semantic reasoning process 249 may also include an ontology prefetcher 506 that is configured to download one or more of ontologies 502a from cloud service 302, prior to semantic reasoner 504 needing them. To do so, ontology prefetcher 506 may use machine learning, to determine ontology-path prediction scores for each of the ontologies 502 that define the domain knowledge for semantic reasoner 504. Further, ontology prefetcher 506 may build a dependency graph of the ontologies 502 used by semantic reasoner 504, to determine the execution dependencies.

As a first step, ontology prefetcher 506 may calculate the ontology path prediction probabilities for semantic reasoner 504. Said different, ontology prefetcher 506 may obtain data indicative of one or more execution sequences of semantic reasoner 504 (e.g., the sequence of ontologies 502a used by semantic reasoner 504), such as by monitoring the execution of semantic reasoner 504, logs generated by semantic reasoner 504, and/or by monitoring the ontology requests sent by semantic reasoner 504 to cloud service 302. In turn, ontology prefetcher 506 may calculate the probabilities of semantic reasoner 504 transitioning from using a particular ontology 502a to using another particular ontology 502. Note that during this period, semantic reasoner 504 may operate under its default mode of operation, requesting ontologies 502a from among ontologies 502 for download, as needed.

In some embodiments, ontology prefetcher 506 may calculate the ontology path prediction probabilities using a two-dimensional data structure as follows:

TABLE 1

| Ontology | Transition to A | Transition to B | Transition to C | . . . |
|---|---|---|---|---|
| A | 0 | P_{AB} | P_{AC} | . . . |
| B | P_{BA} | 0 | P_{BC} | . . . |
| C | P_{CA} | P_{CB} | 0 | . . . |
| . . . | . . . | . . . | . . . | . . . |

To calculate the probabilities, ontology prefetcher 506 may represent ontologies 502a as a directed acyclic graph,

ontology_transitions_graph[MAX_ONTOLOGIES][MAX_ONTOLOGIES]. For illustrative purposes, the term ‘parent ontology’ refers to an ontology that encompasses is other ontologies. Pseudocode for the formation of such a graph is as follows:

```
count_transitions = 0;
A: For all ontologies, execute the below loop:
current_ontology = start_ontology;
while (current_ontology != last_ontology)
{
if ontology j is executed after the current_ontology do:
  {
  ontology_transitions[current_ontology][j]++
  count_transitions++
  current_ontology = j;
  }
}
B: Compute the execution probability of an ontology as:
ontology_transitions = ontology_transitions/count_transitions;
```

The above is a vector operation, ontology prefetcher 506 may calculate it as an element-by-element division. Using the above approach, ontology prefetcher 506 can then assign probabilities to the edges in the graph that represent transitions by semantic reasoner 504 between ontologies. This can be done because the parent_ontology_graph is a subset of the ontology_transitions_graph constructed above.

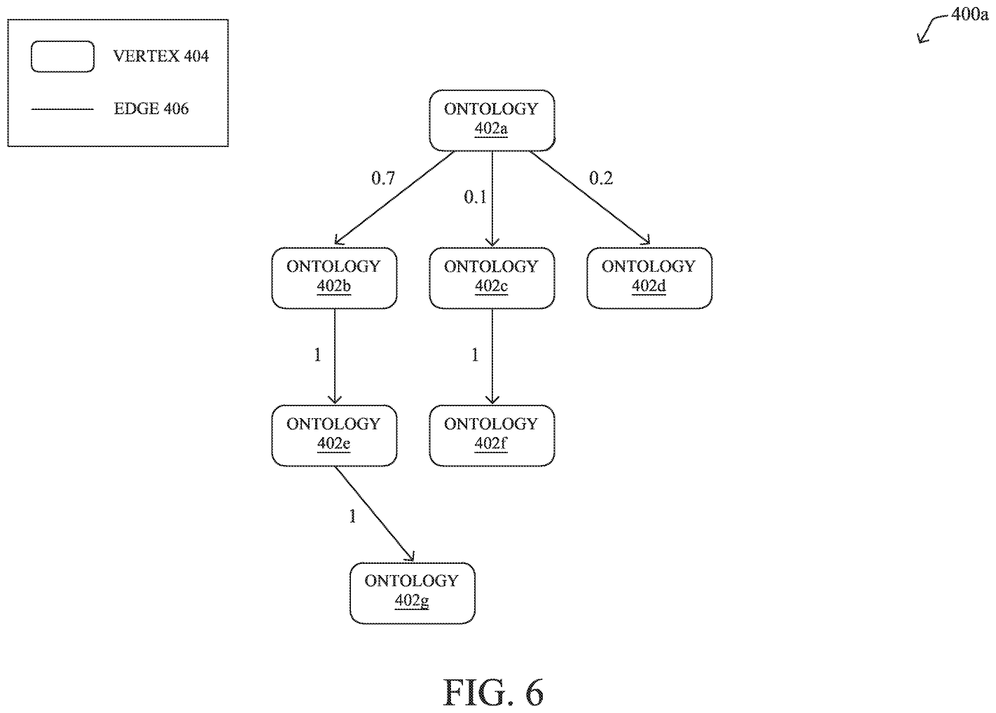

By way of example, FIG. 6 illustrates graph 400a, which is graph 400 described with respect to FIG. 4 with assigned probabilities of use. As shown, semantic reasoner 504 may begin by using ontology 402a. From there, semantic reasoner 504 may transition to using ontology 402b with a probability of 0.7, ontology 402c with a probability of 0.1, and ontology 402d with a probability of 0.2. Similarly, if semantic reasoner 504 transitions to using ontology 402b, it has a probability of 1 of transitioning to using ontology 402e and then ontology 402g. If semantic reasoner 504 transitions to using ontology 402c, it will also transition to using ontology 402f with a probability of 1.

Based on the assigned probabilities in graph 400 in FIG. 6, the overall probability of running a particular child ontology can be computed by multiplying all of the probabilities in the path to the root ontology. For example, the probability of semantic reasoner 504 using ontology 402g can be calculated as 1*1*0.7=0.7. Thus, semantic reasoner 504 is likely to use ontology 402g during its execution, 70% of the time. Similarly, using this logic, the probability score for all of the child ontologies can be computed from graph 400.

Referring again to FIG. 5, in some embodiments, ontology prefetcher 506 may determine the ontology_transitions_graph over all parent ontologies. However, to optimize performance, ontology prefetcher 506 may simply assess an ontology_transitions_graph that is specific to a parent ontology and constructed using training data only from execution of that parent ontology, in further cases. In turn, ontology prefetcher 506 may use the garnered transition information to train a machine learning model to predict ontology transitions by semantic reasoner 504.

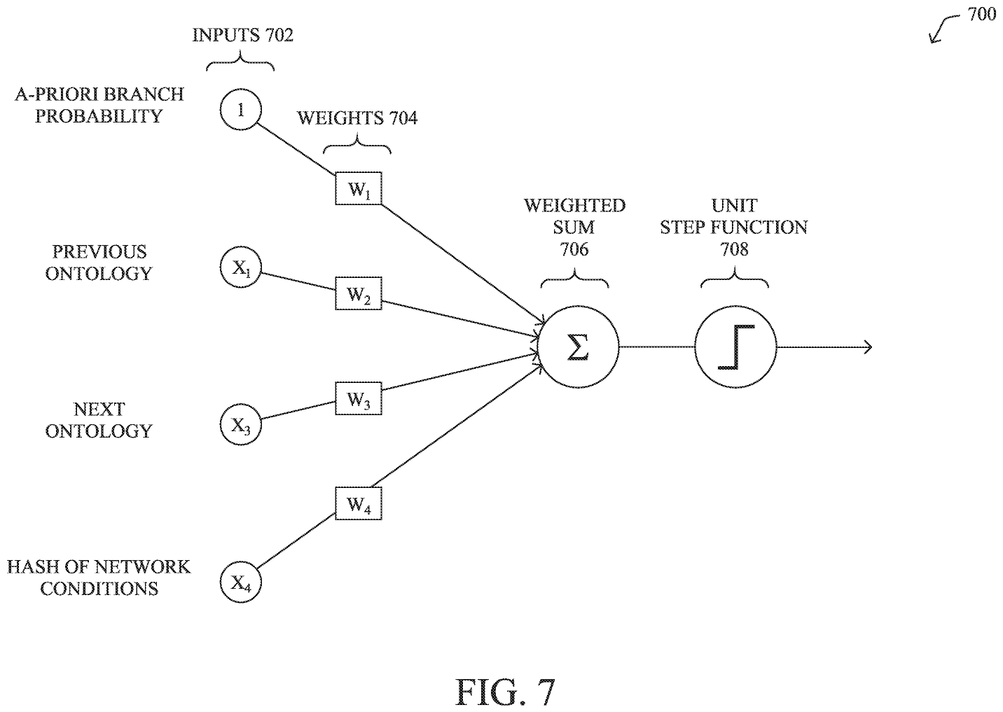

Ontology prefetcher 506 may use any suitable form of machine learning model to predict ontology transitions by semantic reasoner 504. In one embodiment, the model may be a perceptron-based model. FIG. 7 illustrates an example perceptron-based model 700 for predicting use of an ontology by a semantic reasoner, according to various embodiments.

As shown in FIG. 7, the graph with probabilities computed above can be used to drive the inputs 702 of perceptron-based model 700. For example, inputs 702 may include the a-priori branch probability from the graph, the previous ontology, the next ontology and, potentially, a hash of the network conditions under consideration by the semantic reasoner. In accordance with perceptron design principles, weights 704 are applied to inputs 702 and their weighted sum 706 computed and sent to a unit step function 708.

The weighted sum 706 between the values of inputs 702 and weights 704 can mathematically be determined with the scalar-product <w, x>, where x is the input value and w is its weight. To produce the behavior of ‘firing’ a signal (+1), a signum function sgn( ) can be used to map the output to +1 if the input is positive, and map the output to −1, if the input is negative. Thus, perceptron-based model 700 can mathematically be modeled by the function y=sgn(b+<w, x>), where b is the bias (e.g., the default value when all feature values are zero). The techniques herein propose using decision factors such as the apriori probability calculated above (heavily weighted), previously used ontologies, and the current execution conditions, to determine whether the semantic reasoner will use a particular ontology.

If perceptron-based model 700 indicates that the semantic reasoner will execute a particular ontology (e.g., its output is 1), ontology prefetcher 506 can simply raise the probability of the ontology_transitions[i][j]=1 and use it with the rest of the framework. As would be appreciated, the advantage of using perceptron-based model 700 over the raw probabilities calculated above is that doing so adds intelligence about the current execution context, which significantly reduces the chances of mis-prediction. However, further embodiments provide for simply using the base probabilities for purposes of prediction. In addition, the advantage of using a perceptron-based model is that it does not require expensive mechanisms like back propagation for training. Using a simple error value, and a max limit on the loop with initial random weights, this model can be easily trained.

Referring again to FIG. 5, ontology prefetcher 506 may also build an execution dependency graph that indicates whether a particular child ontology is dependent on the execution outcome of its parent ontology. Indeed, some ontologies may be used independently by semantic reasoner 504, without use of their parent ontologies. To do so, ontology prefetcher 506 may build this execution_dependency_graph[N][N] per parent ontology, in some embodiments. For example, the following pseudocode illustrates how ontology prefetcher 506 may build such a graph:

```
if ontology j depends on ontology i for execution
  set execution_dependency_graph[i][j] = 1;
else
  set execution_dependency_graph[i][j] = 0;
```

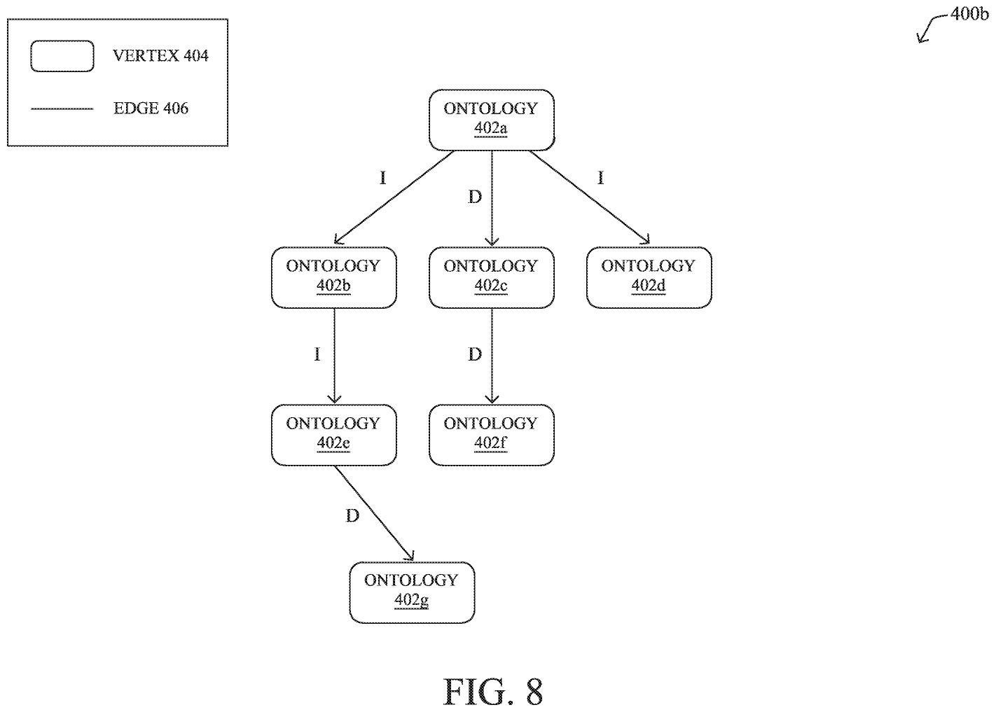

FIG. 8 illustrates an example execution dependency graph 400b for a semantic reasoner with dependency labels. Continuing the example of graph 400 shown in FIG. 4, the ontology prefetcher may also mark edges 406 of graph 400, to indicate whether use of one ontology by the semantic reasoner is dependent on an outcome of the semantic reasoner using another ontology (e.g., by assigning ‘I’ if independent and ‘D’ if dependent). For example, use of ontology 402c is dependent on the outcome of the execution of ontology 402a. Conversely, use of ontology 402b is independent of the outcome of the use of ontology 402a. In various embodiments, such information can be used to only prefetch ontologies whose use is independent of how its parent ontology is executed.

Referring yet again to FIG. 5, ontology prefetcher 506 may use the probabilistic scores from its machine learning model, as well as its generated execution dependency graph, to select one or more ontologies 502 to prefetch. For example, based on the available resources of the device executing process 249, ontology prefetcher 506 may select the set of N highest probability ontologies 502 for prefetching from service 302. Pseudocode for such an action is as follows:

```
For all ontologies in the parent_ontology_graph[ ][ ]
{
Sort the probability of running ontologies P_run( )
From the sorted list, look at each ontology j such that if P_run(j) > Thresh
  if (!execution_dependency_graph[current_ontology[j])
    prefetch_ontology(j)
}
```

For example, assume that ontology prefetcher 506 determines that semantic reasoner 504 is currently executing ontology 402a shown in FIG. 8 (e.g., one of the already downloaded ontologies 502a) and that the probability threshold, Thresh, is set to 0.4. In such a case, ontology prefetcher 506 may prefetch ontologies 402b and 402e, as these ontologies are independent of the execution of their parent ontologies and have associated probabilities (e.g., either base probabilities or as computed by the machine learning model) are above the defined threshold. Conversely, ontology prefetcher 506 may not prefetch ontology 402d, as it has a much lower probability of use by semantic reasoner 504. In some embodiments, the prefetching of ontologies can also be performed in conjunction with a resource-freeing mechanism. For example, ontology prefetcher 506 may remove from local memory any ontologies 502a that have not been used in a certain period of time or based on other criteria.

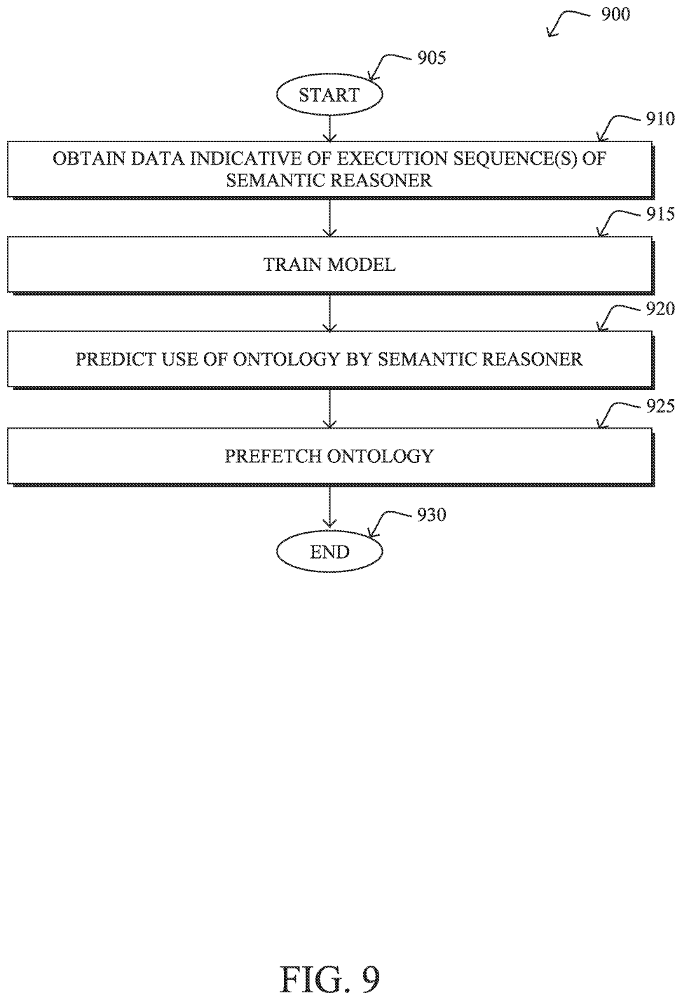

FIG. 9 illustrates an example simplified procedure for prefetching an ontology for a semantic reasoner, in accordance with one or more embodiments described herein. For example, a non-generic, specifically configured device (e.g., device 200) may perform procedure 900 by executing stored instructions (e.g., process 248 and/or 249). The procedure 900 may start at step 905, and continues to step 910, where, as described in greater detail above, the device may obtain data indicative of one or more execution sequences of a semantic reasoner. In general, such sequences may indicate the sequence of ontologies used by the semantic reasoner during execution.

At step 915, as detailed above, the device may train a machine learning model to predict use of an ontology by the semantic reasoner, based on the data indicative of the one or more execution sequences of the semantic reasoner. In some embodiments, the model may be a perceptron-based model and may entail forming an execution dependency graph for the semantic reasoner, based on the obtained data indicative of the one or more execution sequences of the semantic reasoner. In such cases, each vertex of the execution dependency graph represents an ontology. In addition, edges of the graph may be marked to indicate whether use of one ontology by the semantic reasoner is dependent on the semantic reasoner using another ontology. Probabilities can also be assigned to directed edges between vertices of the graph, each probability representing the probability of the reasoner transitioning from one ontology to another.

At step 920, the device may predict, using the machine learning model, use of a particular ontology by the semantic reasoner, as described in greater detail above. For example, the model may predict, given the current ontology in use by the semantic reasoner, that the reasoner will next use the particular ontology.

At step 925, as detailed above, the device may prefetch the particular ontology from another device via the network, prior to the semantic reasoner completing an execution sequence that requires the particular ontology. In doing so, the device does not need to store the particular ontology unless needed. In addition, by prefetching the ontology, the device can avoid any computational delays associated with downloading the ontology, such as from a cloud service. Procedure 900 then ends at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

Accordingly, the techniques herein enhance the deployment of a semantic reasoner by reducing the amount of resources consumed by the ontologies needed to execute the deployed reasoner.

While there have been shown and described illustrative embodiments that provide for dynamic prefetching of ontologies, it is to be understood that various other adaptations and modifications may be made within the spirit and scope of the embodiments herein. For example, while certain embodiments are described herein with respect to using certain models for purposes of predicting ontology use, these models are not limited as such. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
obtaining, by a device in a network, data indicative of one or more execution sequences of a semantic reasoner;
training, by the device, a machine learning model to predict use of an ontology by the semantic reasoner, based on the data indicative of the one or more execution sequences of the semantic reasoner;
predicting, by the device and using the machine learning model, use of a particular ontology by the semantic reasoner; and
prefetching, by the device, the particular ontology from another device via the network, prior to the semantic reasoner completing an execution sequence that requires the particular ontology.

2. The method as in claim 1, wherein the semantic reasoner is configured to determine a root cause of an issue in the network.

3. The method as in claim 1, wherein the other device is part of a cloud service.

4. The method as in claim 1, further comprising:
using the prefetched ontology to complete the execution sequence of the semantic reasoner.

5. The method as in claim 1, wherein training the machine learning model to predict use of an ontology by the semantic reasoner comprises:
forming an execution dependency graph for the semantic reasoner, based on the obtained data indicative of the one or more execution sequences of the semantic reasoner, wherein each vertex of the execution dependency graph represents an ontology.

6. The method as in claim 5, wherein training the machine learning model to predict use of an ontology by the semantic reasoner further comprises:
assigning probabilities to directed edges between vertices of the graph, each assigned probability representing a probability of the semantic reasoner transitioning from one ontology to another.

7. The method as in claim 5, wherein training the machine learning model to predict use of an ontology by the semantic reasoner further comprises:
marking edges of the graph to indicate whether use of one ontology by the semantic reasoner is dependent on the semantic reasoner using another ontology.

8. The method as in claim 1, wherein the machine learning model is a perceptron-based model.

9. An apparatus, comprising:
one or more network interfaces to communicate with a network;
a processor coupled to the network interfaces and configured to execute one or more processes; and
a memory configured to store a process executable by the processor, the process when executed configured to:
obtain data indicative of one or more execution sequences of a semantic reasoner;
train a machine learning model to predict use of an ontology by the semantic reasoner, based on the data indicative of the one or more execution sequences of the semantic reasoner;
predict, using the machine learning model, use of a particular ontology by the semantic reasoner; and
prefetch the particular ontology from another apparatus, prior to the semantic reasoner completing an execution sequence that requires the particular ontology.

10. The apparatus as in claim 9, wherein the semantic reasoner is configured to determine a root cause of an issue in the network.

11. The apparatus as in claim 9, wherein the other device is part of a cloud service.

12. The apparatus as in claim 9, wherein the process when executed is further configured to:
use the prefetched ontology to complete the execution sequence of the semantic reasoner.

13. The apparatus as in claim 9, wherein the apparatus trains the machine learning model to predict use of an ontology by the semantic reasoner by:
forming an execution dependency graph for the semantic reasoner, based on the obtained data indicative of the one or more execution sequences of the semantic reasoner, wherein each vertex of the execution dependency graph represents an ontology.

14. The apparatus as in claim 13, wherein the apparatus trains the machine learning model to predict use of an ontology by the semantic reasoner further by:
assigning probabilities to directed edges between vertices of the graph, each assigned probability representing a probability of the semantic reasoner transitioning from one ontology to another.

15. The apparatus as in claim 13, wherein the apparatus trains the machine learning model to predict use of an ontology by the semantic reasoner by:
marking edges of the graph to indicate whether use of one ontology by the semantic reasoner is dependent on the semantic reasoner using another ontology.

16. The apparatus as in claim 9, wherein the machine learning model is a perceptron-based model.

17. A tangible, non-transitory, computer-readable medium storing program instructions that cause a device in a network to execute a process comprising:
obtaining, by a device in a network, data indicative of one or more execution sequences of a semantic reasoner;
training, by the device, a machine learning model to predict use of an ontology by the semantic reasoner, based on the data indicative of the one or more execution sequences of the semantic reasoner;
predicting, by the device and using the machine learning model, use of a particular ontology by the semantic reasoner; and
prefetching, by the device, the particular ontology from another device via the network, prior to the semantic reasoner completing an execution sequence that requires the particular ontology.

18. The computer-readable medium as in claim 17, wherein the process further comprises:
using the prefetched ontology to complete the execution sequence of the semantic reasoner.

19. The computer-readable medium as in claim 17, wherein training the machine learning model to predict use of an ontology by the semantic reasoner comprises:
forming an execution dependency graph for the semantic reasoner, based on the obtained data indicative of the one or more execution sequences of the semantic reasoner, wherein each vertex of the execution dependency graph represents an ontology

20. The computer-readable medium as in claim 17, wherein training the machine learning model to predict use of an ontology by the semantic reasoner further comprises:
assigning probabilities to directed edges between vertices of the graph, each assigned probability representing a probability of the semantic reasoner transitioning from one ontology to another.
